(19) United States
(12) Patent Application Publication
(10) Pub. No.: US 2011/0232262 A1
(43) Pub. Date: Sep. 29, 2011

(54) RADIAL AND AXIAL COMPLIANT SLIDING SEAL INCORPORATING SPRING CAPTURING FEATURES FOR IMPROVED BEARING PLANE SEALING IN AN ARTICULATING NOZZLE

(76) Inventors: Thomas M. Barry, JR., East Hampton, CT (US); James F. Hyland, JR., Farmington, CT (US)

(21) Appl. No.: 12/748,609

(22) Filed: Mar. 29, 2010

(51) Int. Cl. B64C 29/00; F02K 1/00; F16J 15/34

(52) U.S. Cl. 60/232; 277/377; 277/379

(57) ABSTRACT

A seal assembly (80) adaptable for use between swivel ducts (36, 38, 40) or between a swivel duct (36) and an exhaust duct (81), has a seal (84), a seal carrier (82) and a spring (98). The spring is maintained between the seal carrier and the seal by means of a seal carrier spring holder (88) and a seal retention holder (96) such that the spring urges the seal away from the seal carrier to land the seal on an adjacent swivel duct (40).

This invention was made with government support under Contract No. N00019-02-C-3003 awarded by the United States Navy. The Government has certain rights in this invention.

### BACKGROUND

Some aircraft have the capability to fly at supersonic velocities and have the maneuverability to allow for vertical take offs and landings. The aircraft may have a vertical lift fan near the cockpit that balances vertical lift at the rear of the aircraft provided by a swiveling an engine exhaust nozzle downwardly.

In normal flight mode, the lift fan is inactive and concealed in a fuselage. However, during takeoff or landing, a lift fan clutch may engage the aircraft engine which then acts as part turbo-fan and part turbo-shaft. Some of the engine horsepower is directed from the front of the engine off the low pressure spool to drive the lift fan. The lift fan draws air in through an intake behind the cockpit and accelerates it to provide fan thrust. At the rear of the aircraft, the engine nozzle can be swiveled downwardly to vector thrust downward and balance the lift force of the fan. When the lift fan clutches engages, the engine nozzle area is automatically increased to allow the fan turbine to extract more energy from the combustion gases to drive the lift fan. The exhaust nozzle can also be swiveled to provide pitch and yaw control.

### SUMMARY

According to an example, a seal assembly adaptable for use between swivel ducts or between swivel duct and an exhaust duct, has a seal, a seal carrier and a spring. The spring is maintained between the seal carrier and the seal by means of a seal carrier spring holder and a seal retention holder such that the spring urges the seal away from the seal carrier to land the seal.

According to a further example, a duct having a plurality of sections and having a seal between sections thereof has a seal carrier, a seal and a spring. The spring is maintained between the seal carrier and the seal by means of a seal carrier spring holder and a seal retention holder such that the spring urges the seal away from the seal carrier to land the seal on an adjacent swivel duct.

These and other features of the present invention can be best understood from the following specification and drawings, the following of which is a brief description.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1A is a prior art cross sectional side elevation view of a variable geometry exhaust duct in a cruise position;

FIG. 1B is a prior art cross sectional side elevation view of a variable geometry exhaust duct in a hover position;

FIG. 1C is a prior art exploded perspective view of the exhaust duct assembly;

FIG. 1D is a prior art expanded partially fragmented view of a cooling liner within the exhaust duct assembly;

FIG. 1E is a prior art expanded view of a cooling liner within the exhaust duct assembly;

FIG. 2 is an embodiment schematic partially in section disclosing the nozzles of FIG. 1 and incorporating an embodiment of a seal used and disclosed herein.

FIG. 3 is a side perspective view of a seal mounted on a seal carrier.

FIG. 4 is a side schematic view of the seal and seal carrier in relationship to swivel ducts shown in FIG. 2.

### DETAILED DESCRIPTION OF THE PREFERRED EMBODIMENT

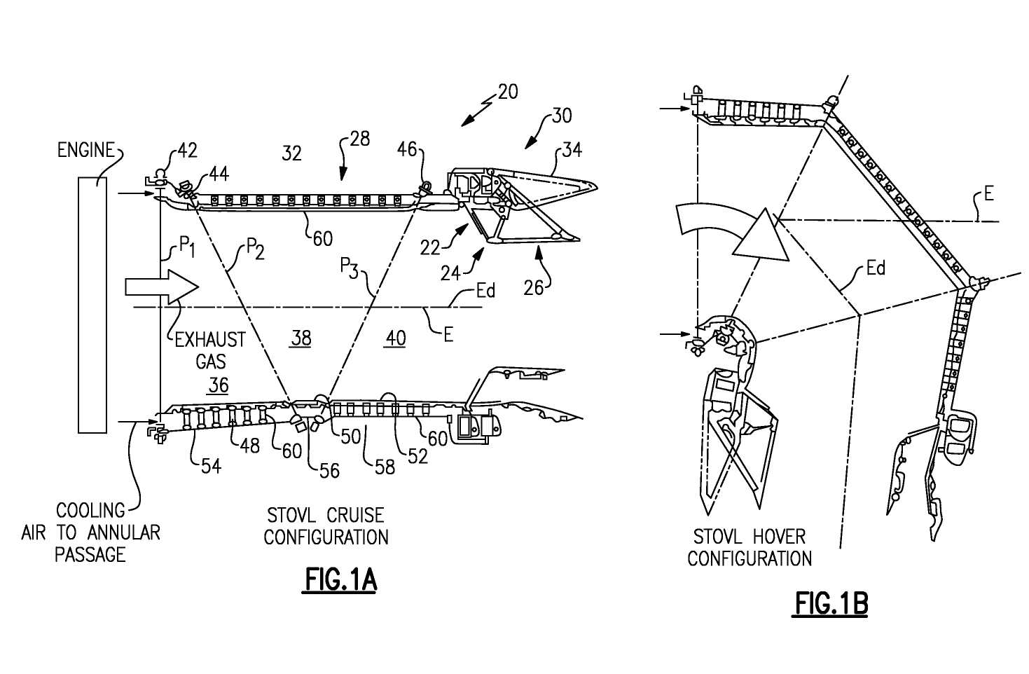

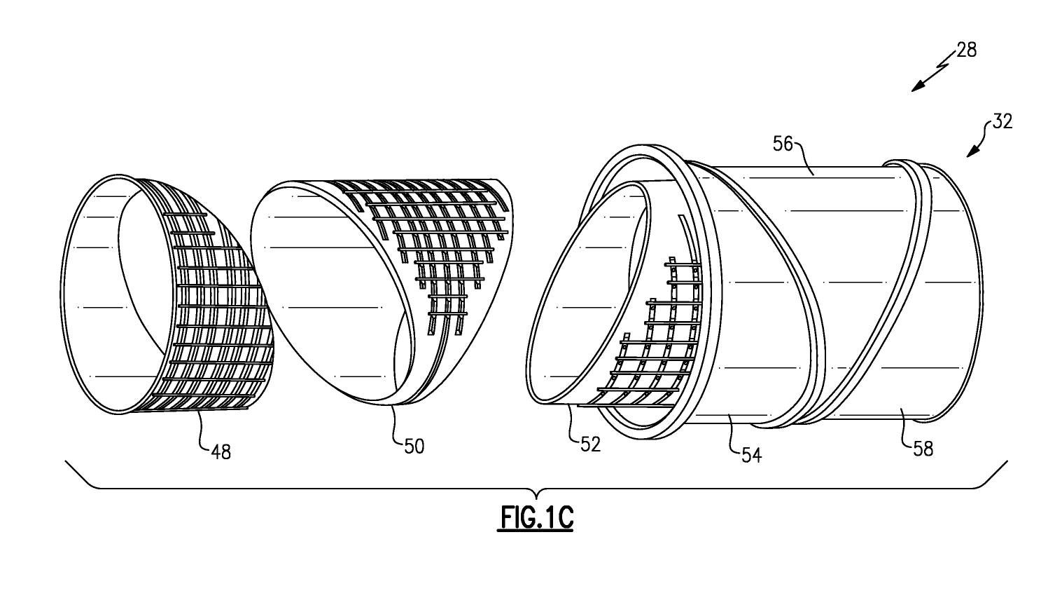

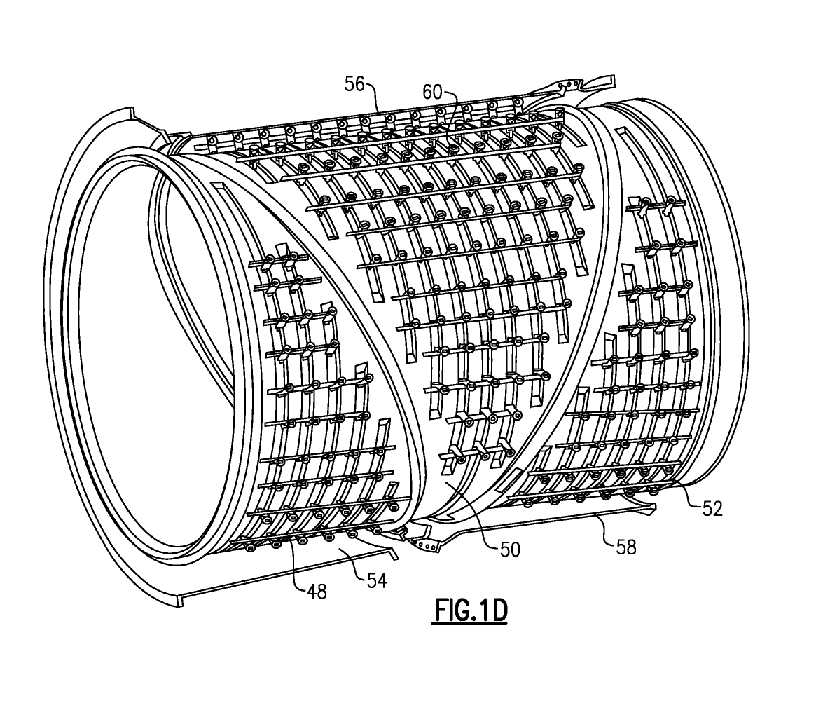

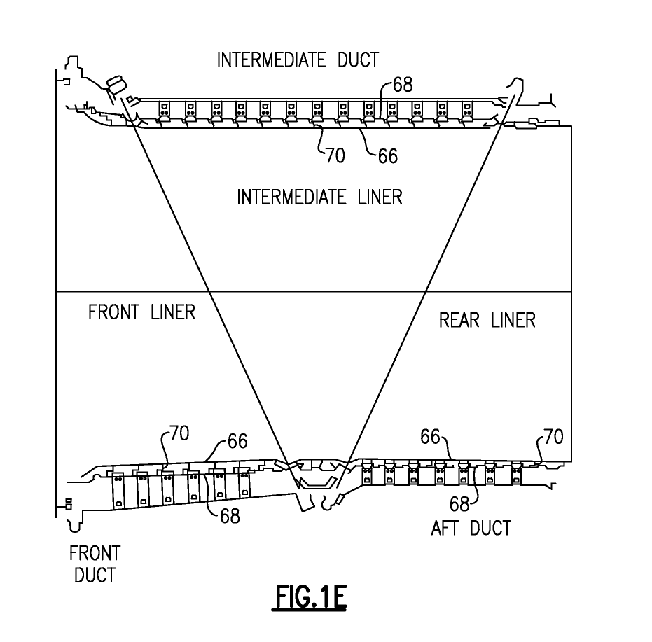

FIG. 1A illustrates a prior art sectional view of an exemplary exhaust duct assembly 20 for a gas turbine engine in both an open position (phantom lines), typical of afterburning operation, and in a closed position (solid lines), typical of non-afterburning operation. The exhaust duct assembly 20 is utilized on an exhaust duct assembly that articulates for use in a short take off vertical landing (STOVL) type of aircraft.

The exhaust duct and nozzle assembly 20 is of the convergent-divergent nozzle type having a convergent flap region 22, a throat region 24, and a divergent flap region 26. The exhaust duct assembly 20 includes an exhaust duct section 28 which communicates with an exhaust nozzle 30.

The exhaust duct section 28 as illustrated herein is a three bearing swivel duct (3BSD) which rotates about three bearing planes (P1, P2, P3) to permit transition between a cruise configuration in which the exhaust duct axis Ed is arranged along an engine axis E (FIG. 1A) and a hover configuration in which the exhaust duct axis Ed is articulated to a position transverse to the engine axis E (FIG. 1B). The outer wall of the exhaust duct section 28 is formed from an exhaust duct case 32 having an aerodynamic nozzle external flap system 34.

The exhaust duct section 28 includes a forward exhaust duct segment 36, an intermediate exhaust duct segment 38 and a rear exhaust duct segment 40. The forward exhaust duct segment 36 is rotatable about the axis E at a first bearing joint 42, the intermediate exhaust duct segment 38 rotates relative to the forward exhaust duct segment 36 at a second bearing joint 44, and the rear exhaust duct segment 40 rotates relative to the intermediate duct segment 38 at a third bearing joint 46. The first bearing joint 42 is disposed along the first bearing plane P1, the second bearing joint 44 is disposed along the second bearing plane P2 and the third bearing joint 46 is disposed along a third bearing plane P3. The second bearing joint 44 and the third bearing joint 46 are generally disposed at a non-normal angle relative the engine axis E.

Each of the forward, intermediate and rear exhaust duct segment 36, 38, 40 include a forward, intermediate and rear cooling liner segment 48, 50, 52 which are exposed to the combustion gases and a forward, intermediate and rear outer duct case segment 54, 56, 58 (FIG. 1C) spaced therefrom by an attachment hanger system 60 (FIG. 1D). The cooling liner segment may be a cylindrical, serpentine or other such shaped member. It should be understood that each of the forward, intermediate and rear cooling liner segment 48, 50, 52 is an assembly that generally includes a hot sheet 66 separated from a corrugated cold sheet 68 by a plurality of stiffeners 70 (also illustrated in FIG. 1E). It should also be understood that the term “corrugation” encompasses various rippled or non-planar surfaces that stiffen the structure and this disclosure is not to be limited to only the specific “corrugation” disclosed in the illustrated embodiment.

Referring to FIG. 1D, the attachment hanger system 60 is attached between the cold sheet 68 of the forward, intermediate and rear cooling liner segment 48, 50, 52 and the respective forward, intermediate and rear outer duct case segment 54, 56, 58. The attachment hanger system 60 at least partially permits for differential thermal expansion between the cold sheet 68 and the hot sheet 66. An annular passage may be defined between the forward, intermediate and rear cooling liner segment 48, 50, 56 and the forward, intermediate and rear outer duct cases 58, 60, 62 to provide passage of cooling air utilized for insulating the forward, intermediate and rear cooling liner segment 48, 50, 56.

Referring now to FIG. 2, the exhaust duct section 28 including the forward exhaust duct segment 36, an intermediate exhaust duct segment 38 and a rear exhaust duct segment 40 are provided with a seal 80 disposed between each segment.

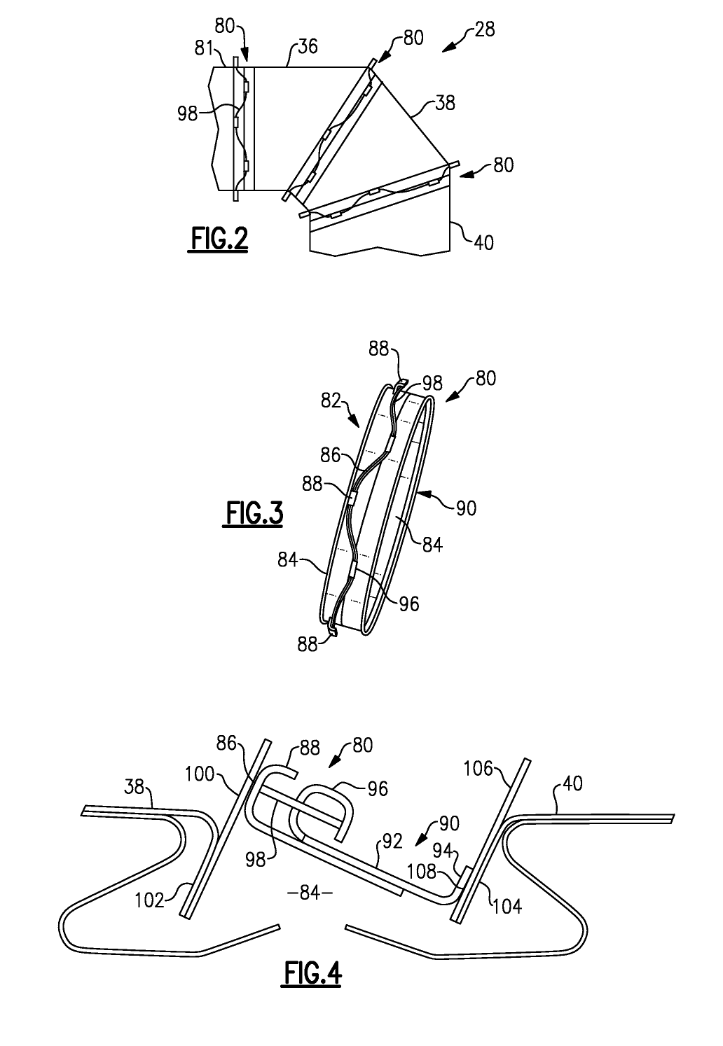

Referring now to FIGS. 2 and 3, a seal 80 that may be disposed between the forward exhaust duct segment 36 and the intermediate exhaust duct segment 38, the intermediate exhaust duct segment 38 and the rear exhaust duct segment 40 and the forward exhaust duct segment 36 and the engine (see FIG. 1A) is shown in detail. Seal carrier 82 has a shaped body 84 such as a cylinder, a diameter, a seal carrier flange 86, and a plurality of seal carrier retention tabs 88 that act as a spring holder extending from said seal carrier flange 86.

The seal 90 has an annular, shaped body 92, such as a cylinder, having a diameter that allows the seal to slide over the seal carrier body diameter and be in contact therewith, a seal land portion 94 and a plurality of ears 96 that also act as a spring holder placed upon the annular body 92 for holding a spring 98 as will be discussed herein.

Because the duct segments rotate relative to each other and expand with heat, the shaped body 84 of the seal carrier 82 and the annular body 92, the spring 98 is wound through and held by the seal retention tabs 88 and the seal ears 96 disposed on the annular body 92 of the seal 90 carrier. The spring 98, which may be a wave or other type of spring, urges the seal 90 axially away from the seal carrier 82. A pressure differential across the seal 80 causes the seal annular body 92 to contact the seal carrier shaped body 84 to effectuate sealing contact therebetween.

Referring now to FIG. 4, an exemplary cutaway view of an exhaust duct 28 of FIG. 2 is shown and the relationship between the exhaust ducts and the seals 80 will be described hereinbelow. It is understood that this description also applies to a seal 80 that may attach to each other exhaust duct and another exhaust duct or the plane, engine or other duct 81 as shown in FIGS. 1 and 2.

For illustrative and not limiting purposes, FIG. 4, shows one of the exhaust ducts 36, 38, or 40 or plane attachment 81 attaching to another exhaust duct and has an annular adapter plate 100 (or extension or flange or the like) attached to an angled inwardly flange 102 on the one of the exhaust ducts etc. by convention means such as welding or riveting or the like. Similarly the seal carrier flange 86 is attached to the annular adapter plate 100 by convention means such as welding or riveting or the like.

An adjacent exhaust duct 36, 38, 40 also has an inwardly extending flange 104 (disposed at an obtuse angle relative to the outer surface of the exhaust duct 28) that carries an annular adapter plate 106 (also attached by conventional means as described herein above to the flange 104) that has a seal land portion 108. The annular adapter plates 106, 100 are parallel to each other so that the seal land portion 94 seats securely on the seal land portion 108 of the annular adapter plate 106 to effectuate a seal therebetween.

As noted above, the spring 98 trapped by the seal carrier tabs 88 and the seal ears 96, urges the land portion 94 against the seal land portion 104 to effectuate a seal therebetween even if the exhaust ducts rotate or move axially relative to each other.

Moreover, because the spring is maintained between the seal carrier tabs 88 and the seal ears 96, the seal will not tend to be caught between the seal carrier 82 and the seal 80 so that the seal 80 maintains the contact needed between the seal carrier 82 and the seal 92 necessary for function as noted hereinabove.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. An apparatus for use with segments of an adjustable duct in an aircraft said apparatus comprising:
a spring,
a seal having a first holding member and having a first shaped body, and
a seal carrier having a second holding member and a second shaped body such that one of said first shaped body or said second shaped body fits within the other of said first shaped body or said second shaped to maintain a sealing relationship therebetween, and wherein the spring is maintained by said first holding member and said second holding member such that said spring urges said seal along said seal carrier.

2. The seal of claim 1 wherein said seal further comprises:
a land portion extending therefrom and adapted for cooperating with a duct to create a seal therebetween.

3. The seal of claim 1 wherein said first shaped body is outboard of said second shaped body.

4. The seal of claim 1 wherein said spring is a wave spring.

5. The seal of claim 1 wherein such that pressure in said duct urges one of said spring carrier or said seal into an other of said spring carrier or said seal.

6. A duct having a plurality of sections, said duct comprising:
a spring,
a seal having a first holding member and having a first shaped body, and
a seal carrier having a second holding member and a second shaped body such that one of said first shaped body or said second shaped body fits within the other of said first shaped body or said second shaped to maintain a sealing relationship therebetween, and wherein said spring is maintained by said first holding member and said second holding member such that said spring urges said seal along said seal carrier towards an adjacent section.

7. The duct of claim 6 wherein said seal further comprises:
a land portion extending therefrom for cooperating with an adjoining section to create a sealing relationship therebetween.

8. The duct of claim 6 wherein said first shaped body is outboard of said second shaped body.

9. The duct of claim 6 wherein said seal carrier is fixedly attached to a section and said seal is urged by said spring into contact with an adjoining section to create a sealing relationship therebetween.

10. The duct of claim 9 wherein said seal carrier is fixedly attached to said section by means of an extension protruding outwardly from said section.

11. The duct of claim 10 wherein said extension is disposed at an obtuse angle relative to an outer surface of said section.

12. The duct of claim 9 wherein said adjoining section has a land surface for cooperating with said seal to create a sealing relationship therewith, said land surface being disposed at an angle relative to an outer surface of said adjoining section.

13. The duct of claim 12 wherein an extension is disposed at an obtuse angle relative to an outer surface of said section.

14. The duct of claim 6 wherein said spring is a wave spring.

15. The duct of claim 6 wherein pressure in said duct urges one of said spring carrier or said seal into an other of said spring carrier or said seal.
